(19) United States
(12) Patent Application Publication
(10) Pub. No.: US 2012/0265610 A1
(43) Pub. Date: Oct. 18, 2012

(54) Techniques for Generating Business Leads

(76) Inventors: Yaacov Shama, Raanana (IL); Tal Segalov, Kfar Sada (IL); Ehud Ben-reuven, New York, NY (US)

(21) Appl. No.: 13/361,376

(22) Filed: Jan. 30, 2012

Related U.S. Application Data
(60) Provisional application No. 61/437,742, filed on Jan. 31, 2011.
(60) Provisional application No. 61/466,035, filed on Mar. 22, 2011.

(51) Int. Cl. G06Q 10/00; G06Q 30/02

(52) U.S. Cl. 705/14.49; 705/1.1

(57) ABSTRACT

A scheme for analyzing businesses and generating business leads is disclosed. A list of company websites can be gathered from a plurality of data sources and combined to produce an aggregated list of companies. Content from the websites of the companies in the list is extracted and stored. Contact information may automatically be ascertained from the website content, if available. The stored content extracted from the websites may then be analyzed to detect the presence of particular features. The listing of companies may then be filtered to produce a subset of businesses that represent potential business leads. The business leads may be provided to a company seeking such leads, and may optionally be provided to an automated marketing system, which is configured to generate and transmit commercial advertisements to the businesses identified as leads.

### CLAIM OF PRIORITY

The present application claims priority to the following two (2) provisional applications, each of which is hereby incorporated herein by reference in their entirety:

U.S. Provisional Application No. 61/437,742, entitled “AUTOMATED ANALYSIS OF COMPANIES FROM THEIR WEB SITE”, filed on Jan. 31, 2011; and

U.S. Provisional Application No. 61/466,035, entitled “WEB BASED BUSINESS-TO-BUSINESS LEAD GENERATION”, filed on Mar. 22, 2011.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present principles are directed business analytics, and more particularly, to embodiments for automatically analyzing website content and generating business leads from the website content.

### BACKGROUND OF THE INVENTION

Website analysis techniques may require a human user to manually access a company's website to determine whether certain features or functions are present. For example, in analyzing a website, the user may determine whether the website provides a form for conveying information, whether the website permits online payment processing or whether a website utilizes a particular type of server. Upon making such determinations, the user must then sort through the websites that were analyzed and identify the websites which represent the best business leads. After identifying the best business leads, the user is further required to manually prepare commercial advertisements for each of the companies which were identified as potential business leads. The above-described methods are inefficient and time-consuming.

### SUMMARY OF THE INVENTION

The present invention is directed toward analyzing companies and generating business leads. In one embodiment, a list of company websites is gathered from a plurality of data sources and combined to produce an aggregated list of companies. Content from the websites of the companies in the list is extracted and stored. Contact information may automatically be ascertained from the website content, if available. The stored content extracted from the websites may then be analyzed to detect the presence of particular features. The listing of companies may then be filtered to produce a subset of businesses, which represent potential business leads. The business leads may be provided to a company seeking such leads, and may optionally be provided to an automated marketing system, which is configured to generate and transmit commercial advertisements to the businesses identified as leads.

As described in further detail below, the present invention intelligently distinguishes between websites which represent good leads and websites which represent bad leads. In certain embodiments, this may be accomplished using a machine learning procedure. The machine learning procedure may include a training procedure which analyzes the content of websites which are already known to represent good leads or bad leads. Using the information derived from the analysis, the machine learning procedure assists in classifying other websites as good leads or bad leads.

In accordance with the present principles, a method is disclosed for analyzing website content. A website associated with a particular business to be analyzed is identified. Content extracted from the website is analyzed to identify at least one feature within the content. A determination is made as to whether a functionality is supported by the website based on the at least one feature identified in the content. Data that indicates the at least one feature or functionality is stored in a database.

In accordance with the present principles, a system is disclosed for analyzing website content. The system includes a website analyzer configured to analyze content extracted from an identified website associated with a particular business to identify at least one feature within the content, and to determine whether a functionality is supported by the website based on the at least one feature identified in the content. The system also includes a database for storing data that indicates the at least one feature or functionality associated with the website.

In accordance with the present principles, a method is disclosed for generating leads. Content extracted from at least one website associated with a business is stored on a non-transitory computer storage medium. The content for each website is examined to determine whether at least one feature is supported. For each business, a determination is made as to whether the business represents a lead based on whether the at least one feature is supported.

In accordance with the present principles, a system is disclosed for generating leads. The system includes a database for storing content extracted from at least one website associated with a business. A website analyzer is configured to examine the content for each website to determine if the content supports at least one feature. A lead identifier is configured to determine whether a business represents a lead based on whether the at least one feature is supported.

These and other features and advantages will become apparent from the following detailed description of illustrative embodiments thereof, which is to be read in connection with the accompanying drawings.

### BRIEF DESCRIPTION OF DRAWINGS

The invention is illustrated in the figures of the accompanying drawings which are meant to be exemplary and not limiting, in which like references are intended to refer to like or corresponding parts, and in which:

FIG. 1 is a schematic illustration of a simplified computer system configured to perform website analysis and generate leads from website content in accordance with one embodiment of the present principles.

FIG. 2 is a flowchart illustrating a method for determining whether a website supports a feature in accordance with one embodiment of the present principles.

FIG. 3 is a flowchart illustrating a method for extracting contact information from website content in accordance with one embodiment of the present principles.

FIG. 4 is a flowchart illustrating another method for extracting contact information from website content in accordance with another embodiment of the present principles.

FIG. 5 is a lead generation system in accordance with one embodiment of the present principles.

FIG. 6 is an exemplary system for analyzing a company using external sources in conjunction with the company's website content.

FIG. 7 is a schematic illustration of a lead generation system that uses a machine learning procedure to identify business leads in accordance with one embodiment of the present principles.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

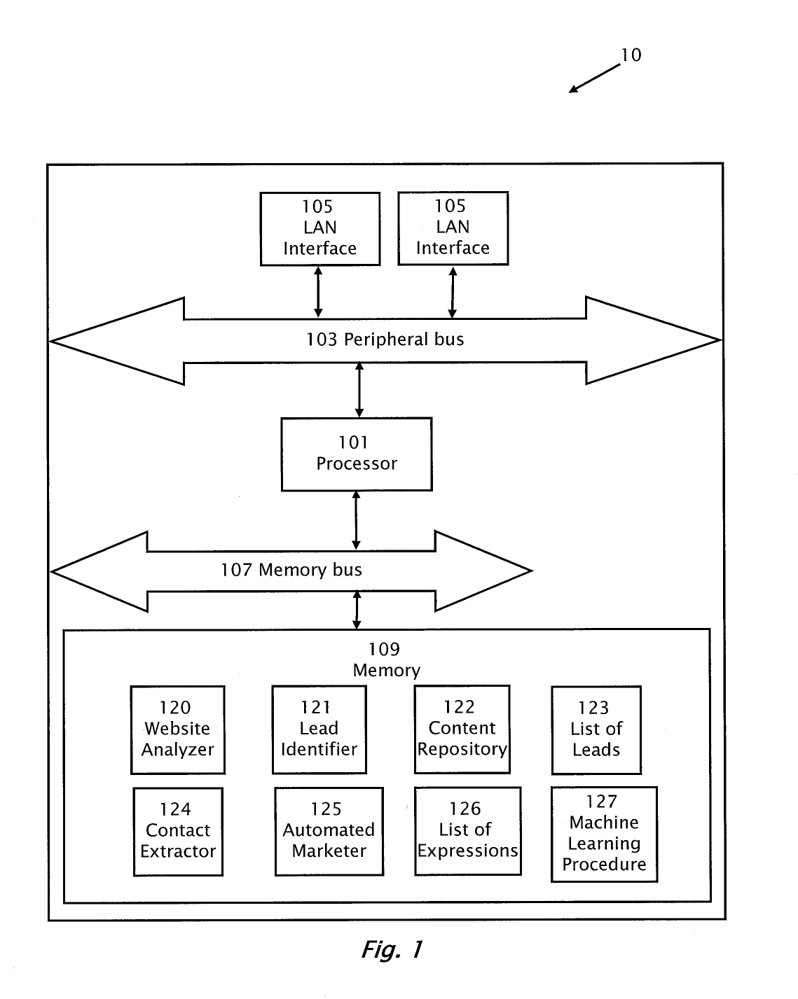

Referring now to the drawings in which like numerals represent the same or similar elements and initially to FIG. 1, a simplified computer system 10 is disclosed for performing website analysis and generating leads from website content in accordance with an embodiment of the present principles. The system 10 includes a processor 101 and a local area network (LAN) or other network interface 105 operatively connected to processor 101 with a peripheral bus 103. A storage mechanism includes a storage memory 109 and a memory bus 107 for storing data in the storage memory 109. The storage memory 109 may represent random access memory (RAM), a disk, or any other type of storage medium.

In this particular embodiment, a website analyzer 120, lead identifier 121 and contact extractor 124 are stored in the memory 109. The website analyzer 120 is configured to perform an automated analysis of one or more websites without the manual assistance of a user. For instance, the website analyzer 120 may identify features which are provided by a website.

Exemplary features which may be identified by the website analyzer 120 may include: words appearing in the text of the site, features indicating online payment processing (e.g., the ability to process credit or debit card transactions), forms for uploading content (e.g., HTML forms which permit a user to post text to a blog or wiki page, or which permit a user to upload an image or other file), fragments (or patterns) of code (e.g. Javascript), comments left behind (e.g. HTML or Javascript comments), internal or external hyperlinks linking to a particular webpage, or database interaction (e.g., whether the website queries a database or permits users to query a database). The website analyzer 120 may also detect features indicating the website's association with physical devices, such as servers or networking equipment (e.g., routers) utilized by the website, or camera devices (e.g., still image cameras or video cameras) which are under the control of the website or which provide data to be utilized by the website. Even further, the website analyzer 120 can determine certain metric data (e.g., network latency) associated with the website, as well as protocols and cookies used by the website. The above listing of features is not intended to be exhaustive, and it is contemplated that nearly any feature set associated with a website can be identified, or searched for, by the website analyzer 120.

The manner in which the website analyzer 120 ascertains the features which are present on a website can vary. In one embodiment, the website analyzer 120 downloads the website content from one or more websites to a content repository 122 in memory 109 (e.g., a storage disk) and performs a subsequent analysis on the stored contents. In another embodiment, the website analyzer 120 accesses the website content, detects whether the website supports particular features, and only stores information indicating whether a company's website includes the particular features.

To determine whether a feature is present, the website analyzer 120 may utilize a list of expressions 126 including one or more regular expressions that identify patterns associated with certain website features. Generally speaking, “regular expressions” allow for the recognition of particular text strings, characters, words, patterns of characters, or the like. Regular expressions are supported by a number of different programming languages including PHP, Java and C++.

In addition to using regular expressions, the website analyzer 120 can determine whether a feature is supported by a website in other ways as well. For example, the website analyzer 120 may also perform string searches, query a server hosting the website, analyze code embedded in website content, or perform other related operations to identify the presence of a website feature. In certain embodiments, the website analyzer 120 may be configured to parse the text from a website into separate words, discard the common words (also known as “stop words”), and then extract the steam of remaining words. Other techniques for analyzing websites are contemplated and are intended to fall within the scope of the present principles.

Once the content of a website has been examined and the features in the content have been identified, the lead identifier 121 determines whether a company represents a potential business lead. If a company is identified as a lead, the lead identifier 121 stores the company name in a list of leads 123. Data indicating the particular features identified on the website may be stored in the list of leads 123, along with any other data associated with the company (e.g., contact information, employee information, etc.).

The determination as to whether a company represents a business lead can be based on a variety of different criteria. In certain embodiments, the presence of a particular feature on a company's website (or lack thereof) may be the basis for determining whether that company represents a business lead. In other embodiments, the detection of certain physical devices or networking metrics associated with the website can be used to determine whether a company is a lead. However, it should be recognized that the criteria used to determine whether a particular company is a lead can be varied according to the needs of the business or user which is seeking the leads.

As an example, consider the exemplary situation in which a web-based software company has created a software product which permits restaurants to process food orders via an online form, and the online software company is seeking a list of business leads representing potential purchasers of their software. In order to identify the companies which represent business leads, the lead identifier 121 may examine the results of the website analyzer 120 (or otherwise work in conjunction with the website analyzer 120) to identify websites of restaurants and determine whether the identified websites include an online order form. In this example, leads may be represented by the companies that are identified as restaurant businesses and which do not have an online order form. Once identified, these companies may be stored in a marketing report, or other type of lead list 123.

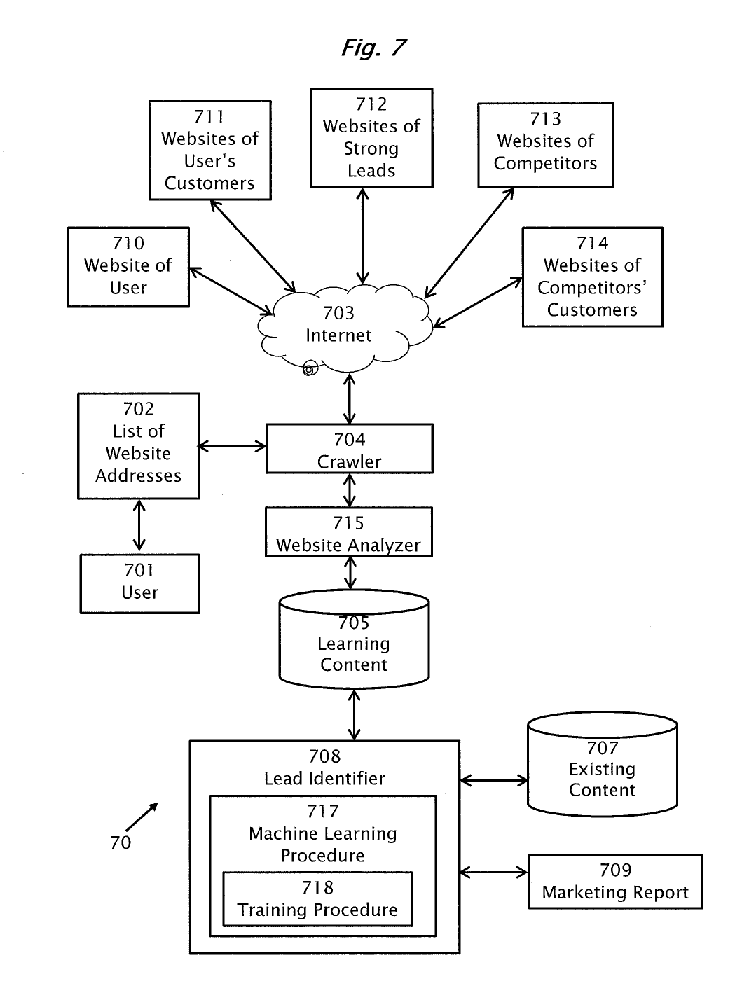

As described in further detail below with reference to FIG. 7, the lead identifier 121 may utilize a machine learning procedure 127 to assist in classifying websites or determining whether a website represents a good lead or a bad lead. To accomplish this, the machine learning procedure may be provided with content from websites which are known to be good leads, or with content from websites which are known to be bad leads. Upon analyzing the content of these websites, the machine learning procedure may recognize features which are indicative, or which are characteristic, of a good lead or a bad lead. The machine learning procedure 127 then uses this information to intelligently determine whether other websites represent good leads or bad leads.

As used herein, a “good lead” generally refers to a lead that can be converted into a specific sales goal or marketing goal at a higher rate than an average lead, while a “bad lead” is a lead that is unable to be converted into a specific sales or marketing goal at a higher rate than an average lead. For example, consider a situation in which sales person wants to sign up leads for a webinar and the average sign up rate is 2% (i.e., for every hundred leads which are sent an invitation, an average of two leads are successfully signed up and join the webinar). In this scenario, a good leads may represent a subset of all leads which are able to be converted at a rate of 4%, while bad leads may represent a subset of all leads which are converted at a rate which is less than 2%. The machine learning procedure 127 described herein is able to identify the subset of good leads which can be converted at a higher rate.

The system 10 in FIG. 1 also includes a contact extractor 124 which is configured to analyze the content of the company's website in order to identify and extract the company's contact information. The extracted contact information may be a phone number, e-mail address, business address, fax number, or any other form of contact information. Preferably, the contact information is stored with the company information in the list of leads 123.

In certain embodiments, an automated marketer 125, or other entity, may be configured to automatically send advertisements or marketing messages to identified leads using the contact information. For example, if the contact information extracted for the business leads is an email address, the automated marketer 125 can prepare an e-mail advertisement and automatically transmit the advertisement to the e-mail addresses associated with the identified leads. Alternatively, if the contact information is a telephone number or a business address, an automated telephone call can be made to the identified phone numbers or mail advertisements can be printed for shipment with envelopes, which include the business address of the business lead. The manner in which advertisements are automatically transmitted to businesses identified as leads may differ depending upon the type of contact information which is extracted from the website content.

Although the website analyzer 120, lead identifier 121, contact extractor 124 and automated marketer 125 are depicted in FIG. 1 as separate and distinct entities, it should be recognized that such is not necessary and that these modules may be included within the same program or entity in other embodiments. Furthermore, each of these entities can be implemented as software, hardware, or combination thereof.

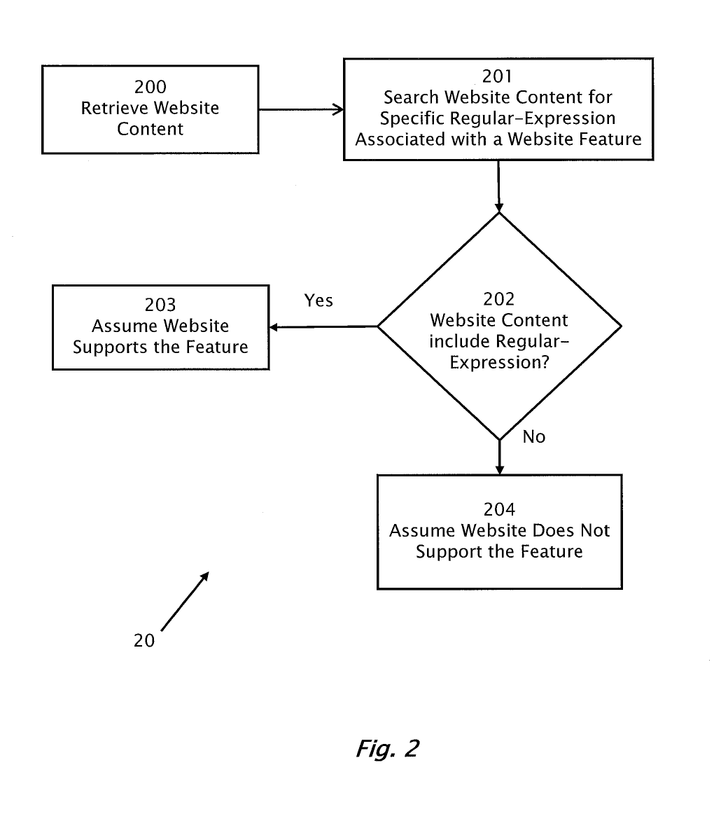

Moving on to FIG. 2, an exemplary method 20 is illustrated for determining whether a website supports a particular feature. The method begins in block 200 by retrieving the content from one or more websites. The retrieval of website content may be performed periodically to account for updates to the websites. Retrieval of the content may include downloading the website content to a content repository 122, or other storage means. In certain embodiments, the website content can be retrieved with a web crawler using techniques which are known in the art, or may be retrieved by accessing the content via a web browser (e.g., Internet Explorer™, Chrome™, etc.). In other embodiments, the website content is retrieved from a database (e.g., a search engine database) which has already extracted and stored the website content.

After the content is retrieved, the feature is searched for within the content using one or more regular-expressions (block 201), e.g., which may be stored in a list of expressions 126. Each regular-expression may be associated with a particular feature being sought and may provide a basis for determining with high probability that a particular feature is present in the website content. It is to be understood that the website content being searched is not limited to the data which is visually displayed, but may also include metadata, underlying program code, HTML tags, cookies, HTTP protocol options, server information, Domain Name information, networking metrics, data related to physical devices, and any other data associated with a website.

Using the above example in which a web-based software company is seeking to identify websites of restaurants that do not have an online ordering form, a variety of different regular-expressions can be utilized to provide a basis for assuming that a restaurant's website does or does not include an online ordering feature. The regular expressions may be stored in a list of expressions 126, which may represent a file, table, database or other data structure. Examples of possible regular expressions that can perform such detection include: “order now”, “order here”, “on.?line. {0,20} order”, “order(ing)?. {0,20} on.?line”. It should be recognized that searching for a particular keyword or phrase is an instance of a regular-expression search.

Upon searching the website content for data which satisfies the regular-expression, a determination is made as to whether the website supports the particular feature associated with the regular-expression (block 202). The determination as to whether a website supports a particular feature may be based on more than one regular expression. Hence, multiple expressions can be searched for within the site content in order to determine whether or not the feature is present.

If it is determined that the regular-expression is satisfied, it may be determined that the website supports the feature (block 203). On the other hand, if the regular-expression is not satisfied, then it may be determined that the website does not support the feature (block 204).

As described in further detail below, a list of business leads 123 can be generated (e.g., using a machine learning procedure) based on whether the content of a website includes a particular feature. Both the detection of a feature, or lack thereof, can both serve as a basis for determining whether a company should be added to the list of leads 123. For example, using the above example involving the detection of an online ordering form, it may be determined that restaurants do not have an online ordering form if the website for the restaurant does not include content which satisfies one or more of the regular-expressions. These restaurants may therefore be added to the list of leads 123 representing potential purchasers for the online ordering software.

In other examples, the presence of a website feature, or the satisfaction of a regular-expression, may trigger a company to be added to the list of leads 123. For example, a company may be seeking to sell videos or movies to businesses which provide online video streaming services. In this case, regular expressions or other criteria may be used to confirm that a website associated with a business provides video streaming services. If it is determined that the website of a business supports video streaming services, the business may be added to the list of leads 123.

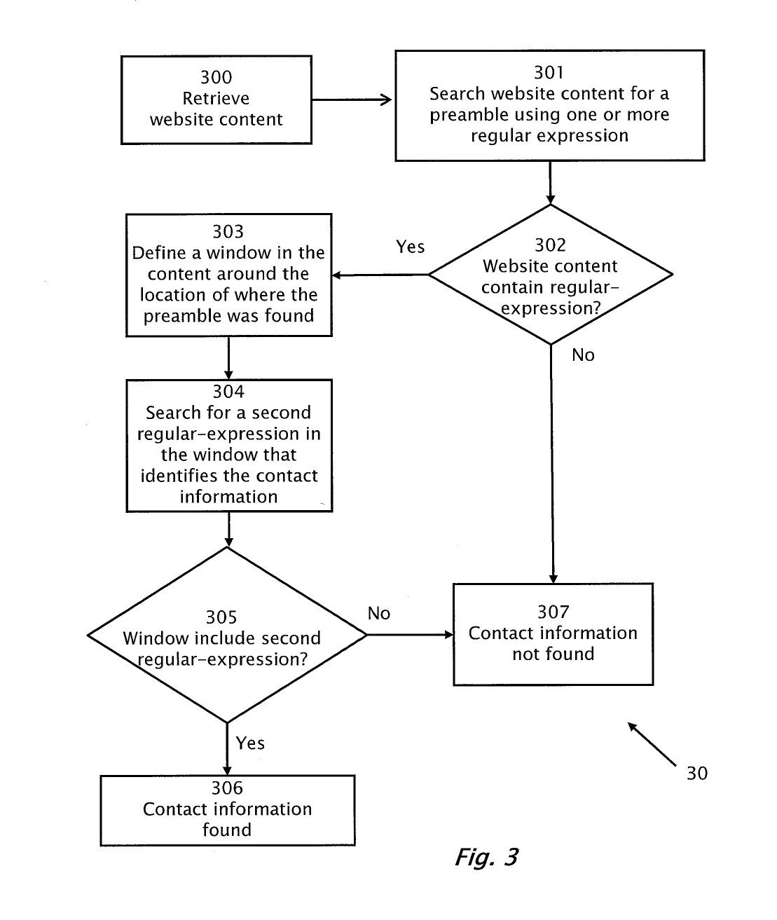

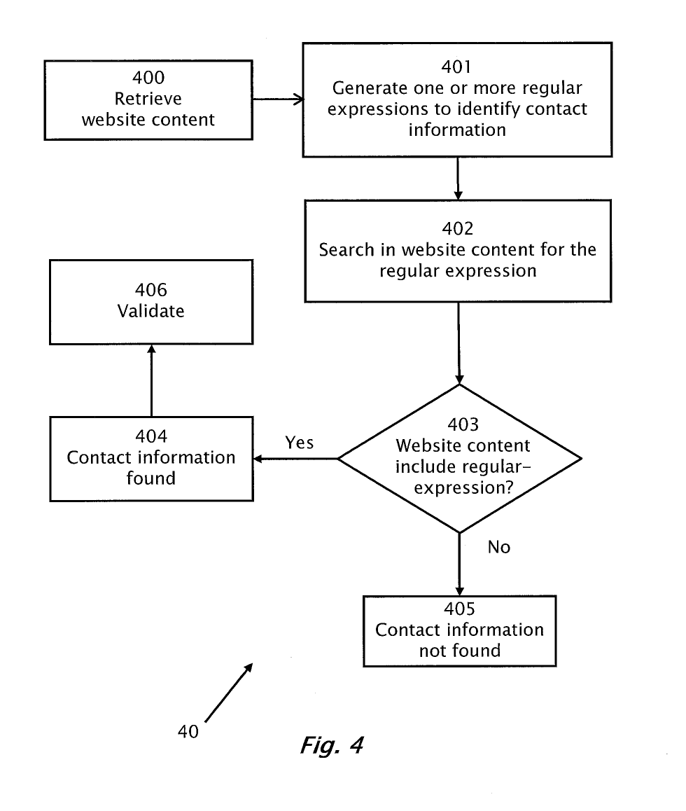

FIGS. 3 and 4 illustrate exemplary methods for extracting contact information from a company's website. These methods may be executed by the contact extractor 124 described above, or another module which is responsible for identifying contact information on a company's website.

Referring initially, to FIG. 3, the method 30 starts by retrieving the content of the website in block 300. In block 301, one or more regular-expressions are used to search the website content for a preamble which is found before contact information. A “preamble” in this context generally refers to a text string, or other data, which precedes contact information or which may be found in the immediate vicinity of contact information. For example, common preambles often associated with email contact information are: “e-mail”, “email”, “contact”, or “mailto”.

Next, in block 302, a determination is made as to whether the website content includes data which satisfies one or more of the regular-expressions. If the website content does not include the regular expression, the method determines that contact information cannot be located (block 307) and the method terminates.

On the other hand, if the website content does include data satisfying the regular-expression (block 302), then a window is defined around the location of where the preamble was found (block 303). The “window” represents an area in the proximity of the identified preamble that will be searched to locate contact information. For example, a window may be specified as 1 to 40 characters occurring after or preceding the identified preamble.

In block 304, a second regular-expression (or second set of regular-expressions) is applied to the content within the window in an attempt to identify the contact information. For example, if the contact is an email address then the second regular-expression may be: “([A−Z0−9. %+−]+@[A−Z0−9−.]+\.[A−Z]{2,4})” where the case of the text is ignored. If the content within the specified window does not satisfy the second regular-expression, the method determines that contact information cannot be located (block 307) and the method terminates. Otherwise, if the second regular-expression is satisfied, the contact information has been located (block 306). The content satisfying the expression represents the contact information and this information may be stored.

FIG. 4 illustrates an alternative method 40 for extracting contact information from a website in accordance with another embodiment of the present principles. The method 40 begins in block 400 where the content of one or more websites is retrieved. In block 401, one or more regular-expressions are generated to identify contact information within the retrieved website content.

In one embodiment, the domain name of the website is used to generate a regular expression that identifies e-mail contact information. This is useful because it is often the case that the domain name of a company's website is the same domain name used for the company's e-mail addresses. Hence, if the company's website domain is “company.com”, then the following regular-expression may be generated in an attempt to identify e-mail contact information within the website content: “(inf|sales|contact|customerservice|contactus|service|admin|office)@company.com”.

One or more regular-expressions may also be constructed to aid in searching for a company's phone number or business address. One way to accomplish this may involve ascertaining the physical location of the business. This can be performed by analyzing the IP address of the website (assuming the website is hosted by the business), by searching an online registry (e.g., the WHOIS registry) which stores location or contact information regarding online resources, or by querying an online database (e.g., Yellow Pages™) that includes contact information for businesses.

In the case that a regular-expression is being generated to identify a phone number, a pre-determined number of area codes may be associated with the location of the website. One or more regular-expressions can then be generated to search for the area codes within the website content.

Similarly, in the case that a regular-expression is being generated to identify a business address, a regular-expression or set of regular-expressions can be generated to search for terms which refer to the location. For example, if the business was located in the state of New York, regular-expressions can be generated to search the content for terms or phases such as “New York” or “NY”, or to search for ZIP codes associated with the state of New York.

After one or more regular-expressions are generated, the expressions are used to search content of the website (block 402) and a determination is made as to whether the website content satisfies the expressions (block 403). If none of the regular-expressions are satisfied, this means the contact information for the company was not identified (block 405) and the method terminates.

However, if one or more of the regular-expressions are satisfied, then it may be determined that the contact information has been identified (block 404). In this case, an optional validation step may be performed (block 406) to confirm that the contact information is accurate. The particular manner of validating the contact information may depend upon the type of contact information that is the subject of validation. In the case of an e-mail address, validation may be performed by interrogating or querying the e-mail server associated with the website to verify that the identified e-mail address is valid. Alternatively, in the case of a phone number or business address, validation may be performed by querying an outside data source, such as the WHOIS registry or Yellow Pages™ directory, to confirm the accuracy of the identified contact information.

It should be recognized that while the methods for identifying contact information in FIGS. 3 and 4 may be advantageous in certain embodiments, the present principles are not limited to these specific procedures. Rather, the present principles encompass all ways of identifying contact information including ways which do not extract the contact information from the content of a website. For example, in certain embodiments, contact information for a company can be identified by directly querying an outside data source, such as the WHOIS registry or Yellow Pages™ directory, or by utilizing a search engine to locate this information. Other ways of identifying contact information are also contemplated.

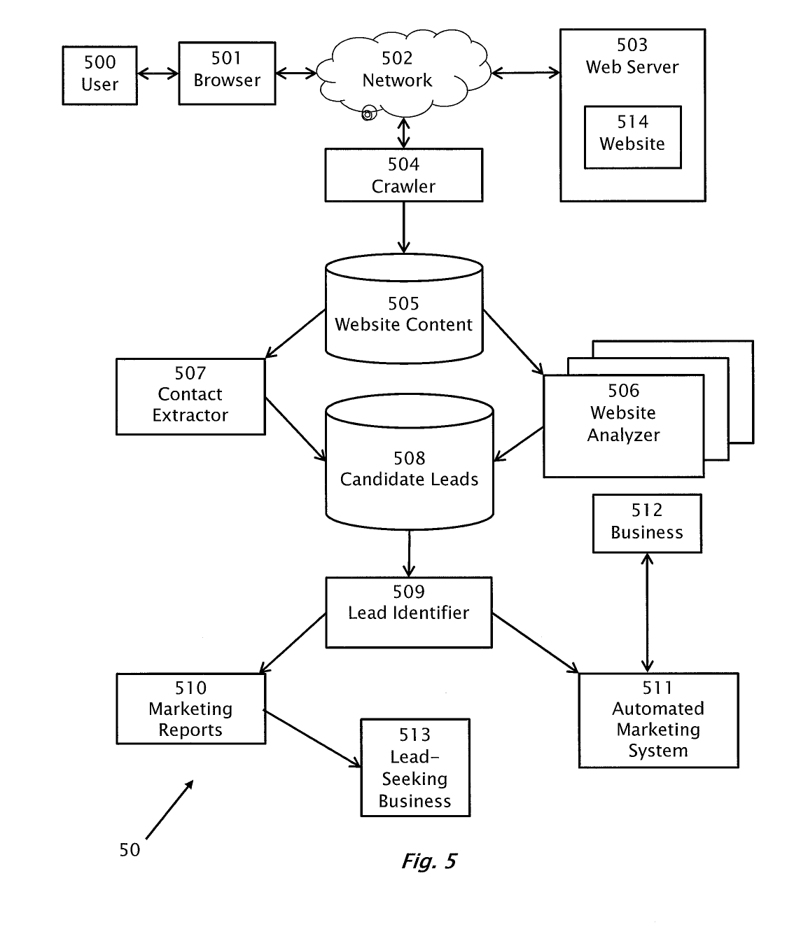

Reference is now made to FIG. 5, which illustrates a lead generation system 50 in accordance with one embodiment of the present principles. A lead-seeking business 513 wishes to target a market base satisfying particular criteria. To accomplish this, the system 50 analyzes the website 514 of one or more businesses 512.

A web server 503 hosts a website 514 for the business 512 which is being analyzed. A user 500 can connect to the server 503 and access the website using a web browser 501. Using known techniques, a crawler agent 504 connects to the web server 503 and accesses the website content stored on the server 503 in a manner which is similar to the browser 501. The crawler agent 504 extracts content (e.g., text, audio files, images, metadata, HTML tags, etc.) from the web server 503 and optionally stores the content in a repository of website content 505. Other information (e.g., data indicating use of physicals devices or metric data associated with the website and server) may also be ascertained and stored in the repository 505.

The content in the storage device 505, or the information directly arriving from the crawler without an intermediate storage, is examined by the website analyzer 506 to determine whether the content includes particular features which would indicate whether or not the business 512 associated with the website 514 represents a lead. The website analyzer 506 may implement the procedure illustrated in FIG. 2, or another procedure, to detect the presence of the features. As explained above, nearly any feature can be searched for within the website content including, but not limited to, an input form, payment processing module or physical devices associated with the website.

After the analysis of the content, potential leads are stored in a database 508, list or other data structure. The determination of whether a company represents a potential lead can be based on the presence of a detected feature, or the lack of detection of a feature, depending upon the particular target market sought by the lead-seeking business 513. Other criteria can also be used to make this determination as well.

Optionally, the contact extractor 507 may attempt to identify contact information for the business 512. To accomplish this, the contact extractor 507 may query outside sources or attempt to extract the information from the website 514 of the business 512. If contact information is identified, it may be stored along with the candidate leads in database 508. The contact extractor 507 may utilize the methods illustrated in FIG. 3 or 4, or other procedures, to extract the contact information.

A lead identifier 509 then filters the entries in the candidate leads database 508 to identify a subset of businesses, which are targeted for marketing. The filtering may be based upon any criteria. In one embodiment, the detection of a feature, or lack thereof, may be used as filtering criteria. In other embodiments, geographic location of the business, or demographic factors associated with the business or business location, may be used to filter the candidate leads 508. In other embodiments, the filtering is based on a score or rank, which is assigned to each business based on a variety of weighted factors. The score may be compared to a threshold value to determine whether a business should be filtered out or whether the business should be included as a lead that is provided to the lead-seeking business 513.

A machine learning procedure may be utilized to determine the criteria that is to be used for filtering websites. To determine or select the criteria, the machine learning procedure may initially analyze the content of websites which are known to be good leads or bad leads. Based on the features (e.g., content features, network features, equipment features, etc.) which were detected during the analysis of these websites, the machine learning procedure identifies patterns in website content which are indicative of whether a website represents a good lead or bad lead. The patterns identified by the machine learning procedure may then be utilized by the lead identifier 509 to select the appropriate filtering criteria and to filter the entries in the leads database 508 accordingly.

After filtering the entries, the resulting leads may be incorporated into a marketing report 510 that is provided to the lead-seeking business or businesses 512. Optionally, the leads may be provided to an automated marketing system 511. Upon receiving the leads, the marketing system 511 automatically generates and transmits marketing materials or advertisements (e.g., e-mail advertisements, printed advertisements for mailing, automated phone calls, etc.) to the businesses that were identified as leads. The advertising materials may be sent on behalf of the lead-seeking business 513.

It is to be understood that the system in FIG. 5, as well as any other system described herein, is not required to locate or include related subsystems or components in a single computer or single site. Rather, the subsystems and components may be separated and can interact through a network, such as the Internet or a LAN. For example, with respect to the system in FIG. 5, the crawler 504 and the repository of website content 505 can be part of an existing search engine system. Similarly, the automated marketing system 511 can be located at a separate site that is responsible for processing marking reports.

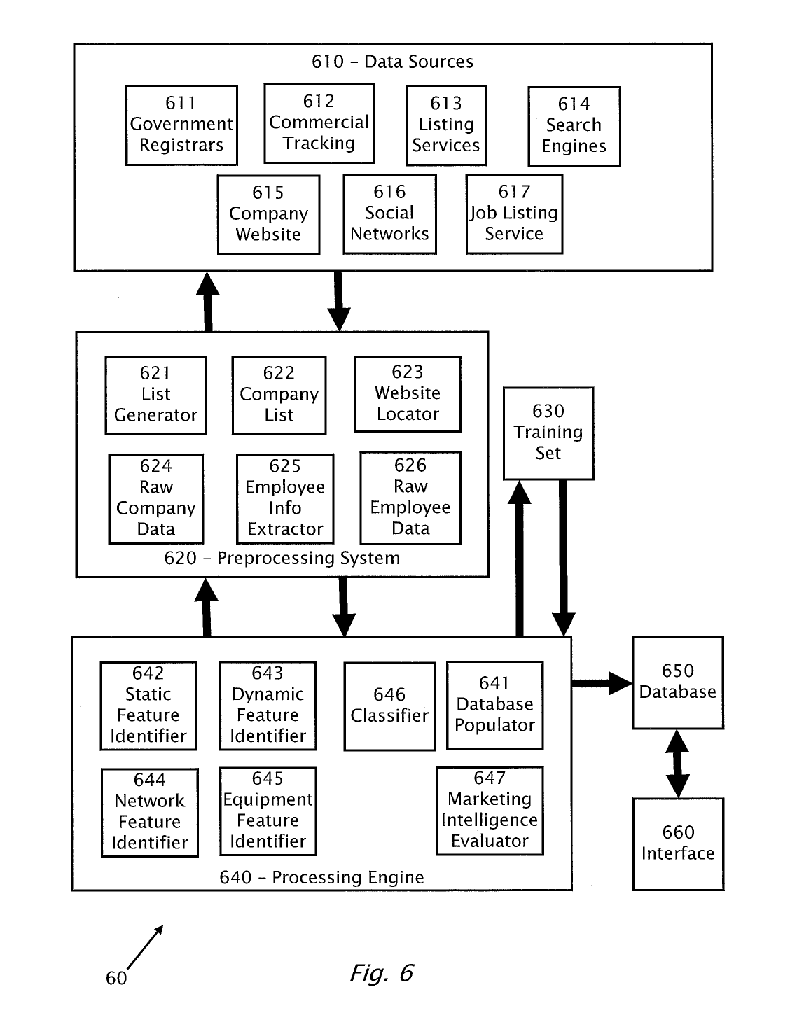

In certain situations, it may be advantageous to utilize information from a plurality of separate external sources in conjunction with the website content to analyze a company or determine whether the company represents a business lead. FIG. 6 illustrates an exemplary system 60 for accomplishing this.

The system 60 in FIG. 6 includes a plurality of data sources 610, a pre-processing system 620 and a processing engine 640. In general, the pre-processing system 620 collects, organizes and integrates data from the plurality of the data sources 610, while the processing engine 640 identifies features in the data and performs other processing operations on the data related to analyzing companies and identifying business leads. Data processed by the processing engine 640 is stored in a database 650, and may be presented to users (e.g., businesses seeking leads) via a display or interface 660 (e.g., a web interface).

The data sources include a government registrar listing of companies 611 (e.g., a government database including a listing of registered businesses with contact information); commercial tracking services 612 (e.g., private companies which specialize in collecting data about businesses for marketing and other purposes); listing services 613 (e.g., websites or businesses which permit companies to list themselves in order to advance their presence to potential customers); search engines 614; the actual website 615 of the company or companies being analyzed; social networks 616; and job searching services 616. Although there are only six data sources depicted in FIG. 6, it should be recognized that additional information from other data sources can easily be incorporated in the system 60. In preferred embodiments, the data provided by all data sources is accessible via a network, such as the Internet.

The pre-processing system 620 gathers data from the data sources 610, optionally stores data for each business in a collection of raw data 624, and integrates the gathered data for processing by the processing engine 640. The pre-processing system 620 may perform a variety of useful tasks including: generating a list of companies; extracting and storing information about a company from the company's website and external information sources; extracting information about the employees of a company from the company's website and external information sources; arranging information collected from different sources into a uniform format to assist in subsequent processing; and locating the website of a company, if unknown. These tasks are described in further detail below.

To compile a list of companies, the company list generator 621 may extract or obtain listings of companies from the government registrars 611, commercial tracking services and websites 612, and listing services and websites 613. The company list generator 621 may compile all of the companies identified by each of these data sources to produce an aggregated company list 622 in which all of the companies are presented in a uniform format. Hence, the company list generator 621 can extract a listing of companies in a first format and a listing of companies in a second format, and combine the two listings into a single list 622 having a uniform format.

The data sources 620 which provide listings of companies may also provide contact information or other data related to the companies. If provided, this data can be extracted and stored in a collection of raw data 624 for each company. In the case that the data sources do not identify the location of a company's website, the website locator 623 can query one or more search engines 614 in order to locate a website for a company. In doing so, the website locator 623 can analyze the domain name, website content (e.g., keywords) and other identifying factors to determine whether a website is the actual website associated with the company being analyzed.

Regardless of how the website address of a company is identified, the content from the website is extracted by the pre-processing system 620. The pre-processing system 620 can extract various types of data from the website itself, from the hardware devices used to host the website or from external devices (e.g., cameras, microphones, sensors, etc.) under the control or providing data to the website. For example, the data extracted from the website may include actual content of the website (e.g., text or images from the websites, contact information, relevant statistical information posted on the website, metadata, embedded code, cookies, etc.), data obtained from interrogating the servers associated with the website (e.g., DNS-related data, data obtained from an e-mail server, routing data, and data relating to virtual private network services, response time, etc.), data obtained from querying a database maintained by the website, data derived from or relevant to the website's control over or relationship with external devices. Other types of data can be collected as well. All of the collected data is stored in a collection of raw data 624 for each company.

The pre-processing system 620 also includes an employee information extractor 625 that gathers data about the employees of a company. The employee information extractor 625 can gather information such as the employee's name, contact information, position in the company, and other information related to the employee. Besides obtaining this data from the actual website of the company, the employee information extractor 625 may also gather employee data from social networks 616 (e.g., LinkedIn™ or Facebook™), job listing services 617, company listing services 613, or any other data source. All collected employee data is stored in a collection of raw employee data 626 for each company. After extracting employee data from a variety of sources, the employee information extractor 625 may integrate and compile this data into a uniform format for subsequent processing by the processing engine 640.

All of the data collected by the pre-processing system 620 is provided to the processing engine 640. The processing engine 640 may perform a variety of different operations on the data including: identifying static and dynamic features on a company's website; identifying networking features related to a company's website; identifying equipment or devices which are used by, under the control of, or otherwise associated with a company's website; classifying companies; determining the importance of a company for each of a plurality of different user subsets; and storing all data related to a company for subsequent retrieval and presentation. A variety of other tasks relating to analyzing a company or marketing may also be performed by the processing engine 640.

A static feature identifier 642 and dynamic feature identifier 643 are responsible for detecting static and dynamic features, respectively, on a company's website. With regard to identifying static features, the static feature identifier 642 may define a time window (e.g., one month or one year), and detect features of a company's website which do not change within the time window. To accomplish this, the system 60 may periodically extract data from a company's website. The static features detected by identifier 642 may represent any of the features discussed above. For example, static features may represent actual content on a website (e.g., text or images), forms, physical devices, network metrics, or other features of website which do not change within the time window.

Similarly, the dynamic feature identifier 643 may also define a time window in which to analyze the content of a website. However, in contrast to the static feature identifier 642, the dynamic feature identifier 643 detects those features that change within the time window. Once again, the system may periodically extract data from the website to determine whether a feature has changed within the time window. Exemplary features which may be detected by the dynamic feature identifier 643 may include: a news feed or event feed on a website which is updated by the company with stories or other content; a portion of website which rotates the display of different advertisements or marketing information; a listing of employees on a company's website which is updated when new employees are added or when employees that left the company are removed; a webpage which provides real-time content from a camera, sensor or other device associated with the website; changes in networking metrics; changes in servers or other hardware; or a wiki page which permits users to post comments or other content.

The processing engine 640 also includes a network feature identifier 644 and an equipment feature identifier 645. The equipment feature identifier 645 can detect the hardware associated with the website. For example, it may determine the type of servers or storage systems utilized by a website, or may determine external devices which are under the control of, or associated with, the website. In certain cases, the equipment feature identifier 645 may utilize the detection of static and dynamic features to identify equipment which is associated with a website.

A variety of different techniques may be utilized by the equipment feature identifier 645. Typically, servers add a unique attribute to their responses, which can uniquely identify the server being used. This unique attribute can be utilized by the equipment feature identifier 645 to detect associated hardware. In addition, it is often the case that a website utilizing a specific database has a specialized administration page to manage the database. While the administration page may require authentication to access the page, the mere existence of the page can serve as an indication that the database is being used by the website. Similarly, web platforms, such as PHP, may include specific test pages that are associated with the platform. The existence of these test pages may indicate that the platform is being used by the website.

Other techniques utilized by the equipment feature identifier 645 may include analysis of cookie data. Typically, tracking and authentication systems use dedicated cookies to track a user session. Each such cookie is made from a string which has a fixed part that uniquely identifies the system. This information can also be utilized by the equipment feature identifier 645.

The network feature identifier 644 may identify a variety of network-related features including data identifying routers or routing protocols associated with the website. Using the internet protocol (IP) address of a website, the network feature identifier 644 can also determine if the website is hosted remotely, and if so, what other businesses are hosted on the same IP address or range of IP addresses that belong to the hosting services. In certain embodiments, the network feature identifier 644 may even be configured to measure the latency of a server, or detect which certificate authority was used to provide a website with a secure socket layer (SSL) certificate.

The features identified by the network feature identifier 644 and equipment feature identifier 645 may include features which are extracted from other servers or devices which are not directly related to a company's website. For example, identifiers 644 and 645 may detect features from servers that supply advertisement content to a company's website, servers that are used to replicate or distribute the content of a company's content, or servers that perform a task or operation associated with embedded code (e.g., JavaScript) in the website content. These external servers can be identified by examining networking parameters of the company's server, the website content or the underlying code of the company's website.

In addition to the components described above which perform feature identification operations, the processing engine 64 also includes a classifier 646. The classifier 646 is configured to classify a company being analyzed into different groupings. Companies may be assigned to one or more groupings.

The classifier 646 may organize companies according to nearly any criteria. For example, companies may be organized based on the business area in which they operate (e.g., restaurants, law firms, accounting firms, etc.) or may be grouped with other companies which are likely to be desired as leads for a lead-seeking business. Companies may also be organized based on whether they include certain features (e.g., an online ordering form or permit online payment transactions), based on the size of the company in terms of employees, or based on the equipment associated with the company's website.

In preferred embodiments, the classifier 646 utilizes training set data 630 in classifying companies. The training set data 630 may include data which is representative of pre-existing company classifications, and this data may be used to assist the classifier 646 in determining placements of companies. The training set data 630 may also be reflective of the choices made by previous users (e.g., lead-seeking businesses). Using the training set data 630, the classifier 646 associates a company with one or more groupings.

The marketing intelligence evaluator 647 determines the relevance or importance of a company being analyzed for each of a plurality of different users that are utilizing the system 60 for different purposes. For example, consider a scenario in which a first user is utilizing the system 60 to identify restaurants which may be potential purchasers of software, a second user is utilizing the system 60 to identify law firms in the New York City area, and a third user is utilizing the system to identify accounting firms with less than ten employees. The marketing intelligence evaluator 647 may determine the importance of each company based on the needs of each of the users (e.g., based on the potential leads which are being sought by each of the users). These determinations may be derived with a machine learning procedure as described herein. A score can be assigned to each company that indicates the relevance or importance of the company to a particular user.

After or during the processing or collecting of a company's data, the database populator 641 may store all relevant data for a company as an entry in a database 650. Specifically, the database populator 641 may store the following information about a company in the database: company name, company web address, identified static and dynamic features on the company's website, identified network and equipment features associated with the company's website, classification data, marketing intelligence data, contact information and employee data. It should be recognized that any other data related to the company can be stored in the database 650 as well.

Once stored, the information in the database 650 is accessible to users (e.g., businesses seeking marketing leads) of the system via an interface 660. In preferred embodiments, the interface 660 is a web interface provided through a web browser. However, other types of interfaces 660 may be used (e.g., an interface provided by a client application stored on a user's computer).

The interface 660 permits users to view the data stored in the database 650. The interface 660 may further be configured to permit querying of the database, or sorting of the underlying information. Companies can be sorted or organized using any criteria including geographic area, size of company, availability of contact information, marketing intelligence score, presence of a particular feature which was detected on the company's website, etc.

In addition, users may utilize the interface 660 to generate marketing reports that identify lists of target companies and associated data. In doing so, the user can narrow the companies to be listed in the marking report by selecting or identifying features which should be present if a company is to be considered a target for marketing purposes.

For instance, using the above example once again, target companies for a user may be businesses which are restaurants and which do not have a means for processing payments on their website. The interface 660 permits the user to trim the listing of companies to identify companies that have been classified as restaurant businesses. The subset of companies can be further trimmed based on whether or not an online order form was not detected on the company's website. The identified companies may then be presented in a marketing report, which may be used by an automated marketing system (e.g., as illustrated in FIG. 5) to automatically generate and transmit advertisements to companies identified in the marketing report.

The interface 660 may also permit users to enter data to be recorded in the database 650. For example, a user can append missing contact information for a company, insert comments about companies, clarify mistakes in the stored data or identify new companies to be analyzed and added to the database 650. Any information entered by the user may then be utilized by the marketing intelligence evaluator 647 in making determinations as to the relevance or importance of a company, or may be used by the classifier 646 and training set 630 in determining how to classify companies. Particularly useful information in this respect may be information entered by a user via the interface 660 indicating the companies that have actually purchased products or services from the user.

FIG. 7 illustrates a variant of the present principles in which a lead generation system uses a machine learning procedure to more intelligently identify business leads for a user.

A user 701 associated with a business which is seeking leads inputs a list of website addresses or URLs 702. The addresses in the list 702 identify the website of the user's business 710, websites of the user's customers 711 and websites of businesses which are already known to be strong leads 712. Optionally, the addresses may also identify websites that belong to competitors of the user 713, or websites that belong to competitors' customers 714. In the case that the user does not know the exact URL of a website, a website locator 623 can be applied as described above.

In certain embodiments, rather than having the user specify a list which includes the URLs of each company, the user may specify a category or range of companies that he or she is interested in, and a comprehensive list of URLs is constructed utilizing a company list (e.g., list 622 in FIG. 6) and a website locator 623. Regardless of how the list of URLs is ascertained, a crawler 704 extracts the data from all of the websites in the list 702.

The website analyzer 715 detects features on the websites in the same manner as described above. For example, as explained above, the website analyzer 715 may detect features related to static and dynamic content, networking, equipment, relevant metrics, etc. The detected features are then associated with the website from which they were identified, and stored in the learning content database 705. Hence, the learning content database 705 stores data that is indicative of the features which are identified for each of the websites in the list of website addresses 702.

The content stored in the learning content database 705 is utilized by lead identifier 708 to generate a machine learning procedure 717. The machine learning procedure 717 is a method or algorithm which can be used to distinguish good leads from bad leads. In an embodiment, the lead identifier 708 may evaluate the features stored in the learning content database 705 and identify other websites (e.g., which are stored in database 707) having the same features. The identified companies may represent strong leads. Other learning methods may be utilized by the feature evaluator 706 as well.

Database 707 may represent a database of content which was derived from a business analysis system (e.g., database 650 in FIG. 6), or may represent an external database (e.g., a database of content associated with a search engine or a database of content associated with a commercial tracking company). Using the machine learning procedure 717, the lead identifier 708 identifies good leads stored in the database 707 based on patterns or features which were detected in the website content of the websites specified in the list 702. If the user supplied a range of websites or a category of interesting websites, such information could be used to filter the content being extracted from the database 707. A subset of the list used from the database 707 can be used in the training stage of the machine learning procedure 717.

In certain embodiments, the machine learning procedure 717 includes a training procedure 718 which analyzes the content of predetermined websites which serve as “good training examples” of leads that are desired. Based on features and patterns detected within the content of the good training examples, the machine learning procedure 717 identifies other websites which represent good leads.

In the exemplary system 70 illustrated in FIG. 7, the user's website 710, websites of the user's customers 711, websites which are known to be strong leads 712, websites of the user's competitors 713 and the websites of the competitors' customers 714 are used as “good training examples” which are used by the machine learning procedure 717 to identify good leads. The machine learning procedure 717 may analyze patterns and features associated with each of these exemplary websites, and use the identified patterns and features as a basis for identifying other websites which represent good leads.

The training procedure 718 may further include the identification of websites which represent “bad training examples” (i.e., websites which represent bad leads or websites which should not be included as a lead). Once again, the machine learning procedure 717 may analyze the content and features of these websites. However, in this situation, the patterns and features associated with these websites is used as a basis for excluding other websites having similar patterns and features as potential business leads for a user or lead-seeking business.

To illustrate an application of the training procedure 718 and machine learning procedure 717, consider an exemplary situation in which a user is seeking leads which represent surfing retail stores that sell apparel over the Internet via an online storefront. To assist the machine learning procedure 717 in identifying potential leads, the user provides a list of URLs which identify online storefronts of well-known surfing apparel companies (e.g., Quiksilver™, Billabong™, Hurley™, etc.). These URLs represent good training examples.

The content of the websites identified by the URLs is retrieved and examined by a website analyzer 715. The website analyzer 715 identifies features for each of these websites and stores this information in a database 705. The machine learning procedure 717 may analyze the detected features and identify features which are common to each of these websites (or at least most of the websites). In this example, the machine learning procedure 715 may determine that all or most of the websites include particular strings (e.g., “surf shop”, “surfboard”, “T-shirts”, etc.), as well as a shopping cart and payment processing module. Given that these features are common to most, if not all, of the websites which were identified as good training examples, the machine learning procedure 717 determines that these features are characteristic of websites which represent good leads. Therefore, in attempting to identify good leads, the lead identifier 708 searches for these features within the content (e.g., the content stored in database 707) of other websites and determines that a website is a good lead if one or more of the features are present within the content.

If a user wishes to further assist the machine learning procedure 717 in identifying leads, the user may also provide a list of URLs which represent bad leads. Providing a list of bad URLs may be advantageous is certain situations where the user anticipates that that the certain types of websites will be incorrectly identified as good leads. For example, with respect to the above scenario, the user may anticipate that websites directed to “web surfing” or “Internet surfing” will be improperly identified as good leads given the dual meaning of the term “surfing”. Therefore, the user may provide a list URLs which identify websites directed to “web surfing” or “Internet surfing”. These URLs identified by the user represent bad training examples.

The content of the websites identified as bad training examples is retrieved and examined by a website analyzer 715, which stores the detected features in a database 705. The machine learning procedure 717 analyzes the detected features and identifies features which are common to each of these websites (or at least most of the websites). In this example, the machine learning procedure 717 may detect a series of strings (e.g., “web surfing”, “web browsing”, “search engine”) which are common to each of the identified websites. Since these features are common to most, if not all, of the websites which were identified as bad training examples, the machine learning procedure 717 may determine that these features are characteristic of websites which represent bad leads. Therefore, in attempting to identify good leads, the lead identifier 708 searches for these features within the website content (e.g., the content stored in database 707) of other websites and determines that a website is a bad lead if one or more of the features are present within the content.

As demonstrated above, the lead identifier 708 is able to intelligently separate good leads from bad leads using the machine learning procedure 717. Upon identifying the websites that represent good leads, the lead identifier 708 may store the good leads in a marketing report 709. The marketing report 709 can be presented to the user 701 or provided to an automated marketing system.

The figures in this disclosure are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Those skilled in the art will appreciate that the invention may be practiced in network computing environments with many types of computer system configurations, including mobile telephones, PDA, pagers, hand-held devices, laptop computers, personal computers, multi-processor systems, microprocessor-based or programmable consumer electronics, network PCs, minicomputers, mainframe computers, and the like. The invention may also be practiced in distributed computing environments where local and remote computer systems, which are linked (either by hardwired links, wireless links, or by a combination of hardwired or wireless links) through a communication network, both perform tasks. In a distributed computing environment, program modules may be located in both local and remote memory storage devices.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for generating leads, comprising:
storing content extracted from at least one website associated with a business on a non-transitory computer storage medium;
examining the content for each website to determine whether at least one feature is supported; and
for each business, determining whether the business represents a lead based on whether the at least one feature is supported.

2. The method as recited in claim 1, wherein the at least one feature may comprise a static feature, dynamic feature, network feature, equipment feature, or a software platform.

3. The method as recited in claim 1, wherein examining the content comprises detecting at least one of:
a server associated with providing hosting services; or
an external device which provides real-time information for display on the website.

4. The method as recited in claim 1, further comprising generating a lead list comprising all businesses which have been identified as leads.

5. The method as recited in claim 4, further comprising automatically generating an advertisement for each business identified in the lead list.

6. The method as recited in claim 5, further comprising automatically transmitting the advertisement to each business identified in the lead list if contact information is available, wherein the advertisements include at least one of an e-mail message, an automated telephone call or a mailing advertisement.

7. The method as recited in claim 1, further comprising utilizing a machine learning procedure which examines data associated with one or more good leads to generate a procedure which distinguishes good leads from bad leads.

8. The method as recited in claim 1, further comprising utilizing a machine learning procedure which examines data associated with one or more bad leads to generate a procedure which distinguishes good leads from bad leads.

9. The method as recited in claim 7, further comprising applying the machine learning procedure to generate a filtered or prioritized lead list.

10. A system for generating leads, comprising:
a database for storing content extracted from at least one website associated with a business, wherein the database is stored on a non-transitory computer storage medium;
a website analyzer configured to examine the content for each website to determine if the content supports at least one feature; and
a lead identifier configured to determine whether a business represents a lead based on whether the at least one feature is supported.

11. The system as recited in claim 10, wherein the at least one feature may comprise a static feature, dynamic feature, network feature equipment feature, or a software platform.

12. The system as recited in claim 10, wherein the website analyzer examines the content to detect equipment associated with a website, the equipment comprising at least one of:
a server associated with providing hosting services; or
an external device which provides real-time information for display on the website.

13. The system as recited in claim 10, wherein the lead identifier is further configured to generate a lead list comprising all businesses which have been identified as leads.

14. The system as recited in claim 13, further comprising an automated marketer configured to automatically generate an advertisement for each business identified in the lead list.

15. The system as recited in claim 14, further comprising automatically transmitting the advertisement to each business identified in the lead list if contact information is available, wherein the advertisements include at least one of an e-mail message, an automated telephone call or a mailing advertisement.

16. The system as recited in claim 10, further comprising a lead identifier which utilizes a machine learning procedure for examining data associated with one or more good leads to generate a procedure which distinguishes good leads from bad leads.

17. The system as recited in claim 10, further comprising a lead identifier which utilizes a machine learning procedure for examining data associated with one or more bad leads to generate a procedure which distinguishes good leads from bad leads.

18. A non-transitory computer storage medium comprising a computer readable program, wherein the computer readable program when executed on a computer causes the computer to:
store content extracted from at least one website associated with a business;
examine the content for each website to determine whether at least one feature is supported; and
for each business, determine whether the business represents a lead based on whether the at least one feature is supported.

19. The computer storage medium as recited in claim 18, wherein execution of the program further causes the computer to utilize a machine learning procedure which examines data associated with one or more good leads to generate a procedure which distinguishes good leads from bad leads.

20. The computer storage medium as recited in claim 18, wherein execution of the program further causes the computer to utilize a machine learning procedure which examines data associated with one or more bad leads to generate a procedure which distinguishes good leads from bad leads.
